(19) United States
(12) Patent Application Publication
(10) Pub. No.: US 2025/0337268 A1
(43) Pub. Date: Oct. 30, 2025

(54) POWER SUPPLY AND BACKUP NETWORK OF COMMUNICATION DEVICE

(71) Applicant: Suzhou MetaBrain Intelligent Technology Co., Ltd., Suzhou (CN)

(72) Inventors: Deyang Hua, Suzhou (CN); An Wu, Suzhou (CN); Lingyan Wang, Suzhou (CN); Jianyu Li, Suzhou (CN)

(21) Appl. No.: 19/260,691

(22) Filed: Jul. 7, 2025

Related U.S. Application Data
(63) Continuation of application No. PCT/CN2023/138960, filed on Dec. 14, 2023.

(30) Foreign Application Priority Data
Jan. 9, 2023 (CN) 202310030517.4

(51) Int. Cl. H02J 9/06; H02J 3/36

(52) U.S. Cl. CPC H02J 9/061; H02J 3/36

(57) ABSTRACT

The present application discloses a power supply and backup network of a communication device. The network includes a medium-low voltage power distribution system, a high voltage battery backup power system, a power distribution system, and a high-voltage direct-current (HVDC) bus system, where the medium-low voltage power distribution system is connected to the power distribution system by the HVDC bus system; the high-voltage battery backup power system is bypassed on the HVDC bus system; the medium-low voltage power distribution system is configured to provide HVDC power for the power distribution system by the HVDC bus system by using input mains power and oil energy backup power; the high-voltage battery backup power system is configured to provide HVDC backup power for the power distribution system by the HVDC bus system; and the power distribution system is configured to distribute, to a connected electrical device, the HVDC power.

### CROSS-REFERENCE TO RELATED APPLICATION

This application is a continuation of International Patent Application No. PCT/CN2023/138960, entitled “Power supply and backup Network of Communication Device” and filed on Dec. 14, 2023, which claims priority to Chinese Patent Application No. 202310030517.4, filed on Jan. 9, 2023 with the China National Intellectual Property Administration and entitled “Power supply and backup Network of Communication Device”. International Patent Application No. PCT/CN2023/138960 and Chinese Patent Application No. 202310030517.4 are hereby incorporated by reference in their entireties.

### FIELD

The present application relates to the field of communications, and in particular to a power supply and backup network of a communication device.

### BACKGROUND

FIG. 1 is a schematic diagram showing an architecture of a power system of an existing communication device according to related art relevant to the present application. As shown in FIG. 1, a conventional communication device is equipped with 1-2 sets of medium-low voltage power distribution systems depending on its level, and each set of medium-low voltage power distribution systems uses mains power as input and oil energy as backup power to enhance reliability of the power system. Both the main and backup power sources are mainly from non-renewable energy, resulting in a large amount of carbon emissions.

The traditional communication device is equipped with a 1-2-path AC (Alternating Current) power bus and an Uninterruptible Power System (UPS) architecture depending on its level to achieve uninterruptible power supply, so as to improve the high reliability of the communication device. Conversion of the mains power and charge-discharge of an internal storage battery during the power supply process are achieved by means of the UPS. In the UPS, when a mains power input is normal, the UPS filters and regulates the mains power before supplying it to a communication device power supply of the communication device, and simultaneously charges an internal battery module of the UPS; when the mains input fails, the UPS immediately converts a DC (Direct Current) power in the battery module by means of an inverter to a AC power for the communication device power supply. In the related art, an AC/DC conversion and an AC/DC conversion of the UPS are main links of energy loss in an electric energy transmission path of the whole power system, the loss being about 5%. Accumulation of significant heat from these losses puts pressure on an air conditioning cooling system, further resulting in more energy loss, i.e., more carbon emissions.

An AC power output from the UPS requires a plurality of 1-2-path isolated Power Distribution Units (PDUs) to distribute power to the communication device, achieving a plurality of 1-path or 2-path or multi-path AC bus power systems. The isolated PDU incurs a loss of approximately 4%. The accumulation of significant heat from these losses also puts pressure on the air conditioning cooling system, similarly resulting in more energy loss, i.e., more carbon emissions. The 220 Vac AC bus is not conducive to distributed backup power to improve the power supply and backup reliability of the important nodes of the communication device.

Inside the communication device, AC-input Power Supply Units (PSUs) are used to convert AC power into usable DC power (such as 48V, 12V, and the like) to supply power to communication device electric units. In a process of PSU AC-DC conversion, Power Factor Correction (PFC) circuit is needed to improve the power factor, resulting in about 2% loss, which further aggravates the heat loss and carbon emissions.

Regarding a problem in the related art of large energy losses and the like caused by multi-stage conversion in an electric energy transmission path of a power system, no effective solution has been proposed.

### SUMMARY

The embodiments of the present application provide a power supply and backup network of a communication device.

According to some embodiments of the present application, a power supply and backup network of a communication device is provided. The power supply and backup network of the communication device includes a medium-low voltage power distribution system, a high-voltage battery backup power system, a power distribution system, and a high-voltage direct-current (HVDC) bus system, where the medium-low voltage power distribution system is connected to the power distribution system by means of the HVDC bus system; and the high-voltage battery backup power system is bypassed on the HVDC bus system; the medium-low voltage power distribution system is configured to use input mains power and oil energy backup power to provide HVDC power for the power distribution system by means of the HVDC bus system; the high-voltage battery backup power system is configured to provide HVDC backup power for the power distribution system by means of the HVDC bus system; and the power distribution system is configured to distribute, to an electrical device connected to the power distribution system, the HVDC power transmitted on the HVDC bus system.

In some exemplary embodiments of the power supply and backup network, the medium-low voltage power distribution system is configured to charge the high-voltage battery backup power system in response to normal power supply; and the high-voltage battery backup power system is configured to discharge the HVDC bus system in response to abnormal power supply in the medium-low voltage power distribution system.

In some exemplary embodiments of the power supply and backup network, the high-voltage battery backup power system is further configured to smooth voltage fluctuations on the HVDC bus system.

In some exemplary embodiments of the power supply and backup network, the power supply and backup network further includes a new energy power supply and backup system, where the new energy power supply and backup system is connected to the HVDC bus system; the new energy power supply and backup system is configured to use the input new energy to provide the HVDC power for the power distribution system or the HVDC backup power for the power distribution system by means of the HVDC bus system.

In some exemplary embodiments of the power supply and backup network, the new energy power supply and backup system includes: a first new energy power supply and backup system and a second new energy power supply and backup system, where the first new energy power supply and backup system is disposed at a remote end of the electrical device and the second new energy power supply and backup system is deployed locally at the electrical device.

In some exemplary embodiments of the power supply and backup network, the first new energy power supply and backup system and the medium-low voltage power distribution system are configured as mutually redundant power supply systems; and the first new energy power supply and backup system and the high-voltage battery backup power system are used as mutually redundant backup power systems.

In some exemplary embodiments of the power supply and backup network, in response to a determination that the energy in the first new energy power supply and backup system is higher than a first threshold, the first new energy power supply and backup system is configured as a primary power supply source for the electrical device, and the medium-low voltage power distribution system is configured as a secondary power supply source for the electrical device.

In some exemplary embodiments of the power supply and backup network, the first new energy power supply and backup system is further configured to perform trickle charging energy storage for the high-voltage battery backup power system.

In some exemplary embodiments of the power supply and backup network, the second new energy power supply and backup system and the medium-low voltage power distribution system are configured as mutually redundant power supply systems; the second new energy power supply and backup system and the high-voltage battery backup power system are configured as mutually redundant backup power systems; and the second new energy power supply and backup system and a first distributed power supply and backup unit disposed in the electrical device are further configured as mutually redundant backup power systems.

In some exemplary embodiments of the power supply and backup network, in response to a determination that the energy in the second new energy power supply and backup system is higher than a second threshold, the second new energy power supply and backup system is configured as a primary power supply source for the electrical device, and the medium-low voltage power distribution system and the first new energy power supply and backup system are configured as a secondary power supply source for the electrical device.

In some exemplary embodiments of the power supply and backup network, the second new energy power supply and backup system is further configured to perform constant-current energy storage or trickle charging energy storage for the high-voltage battery backup power system; or, the second new energy power supply and backup system is further configured to perform the constant-current energy storage or the trickle charging energy storage for the first distributed power supply and backup unit disposed within the electrical device.

In some exemplary embodiments of the power supply and backup network, the power supply and backup network further includes a bidirectional feed system, where the bidirectional feed system is configured to store valley period surplus energy from the new energy power supply and backup system into an energy storage warehouse, and supply power to a power grid after the energy storage warehouse is fully charged; and the bidirectional feed system is further configured to provide the energy stored in the energy storage warehouse or the energy provided by the power grid to the electrical device during peak power consumption period of the electrical device.

In some exemplary embodiments of the power supply and backup network, the power supply and backup network further includes a shared energy storage system, where the shared energy storage system is connected to the HVDC bus system; the shared energy storage system is configured to store energy to the distributed power supply and backup unit deployed on the electrical device or release energy to the distributed power supply and backup unit disposed on the electrical device by means of the HVDC bus system.

In some exemplary embodiments of the power supply and backup network, the shared energy storage system is configured to allocate a second distributed power supply and backup units for providing backup power in response to a failure of a power system for supplying power in the power supply and backup network; and the shared energy storage system is further configured to switch the backup power system to the first distributed power supply and backup unit disposed on the electrical device before the energy stored in the backup power system in the power supply and backup network is discharged to a limiting threshold in response to the failure of the power system for supplying power in the power supply and backup network.

In some exemplary embodiments of the power supply and backup network, the electrical device includes: a communication device, where an HVDC Power Supply Unit (HVDC PSU) is disposed in the communication device, and the HVDC PSU includes a power supply conversion apparatus that conforms to DC input.

In some exemplary embodiments of the power supply and backup network, the power supply conversion apparatus includes: a DCDC isolation converter, a self-backup power DCDC isolation converter, or a self-redundant DCDC isolation converter.

In some exemplary embodiments of the power supply and backup network, the communication device is further deployed therein a third distributed power supply and backup unit, where the third distributed power supply and backup unit is configured to provide backup power to the communication device.

In some exemplary embodiments of the power supply and backup network, the power supply and backup network further includes an intelligent management and control bus system, where the intelligent management and control bus system is connected to all functional systems included in the power supply and backup network; and the intelligent management and control bus system is configured to monitor all the functional systems, and regulate and control a power supply system and a backup power system of the power supply and backup network according to a working state of all the functional systems.

In some exemplary embodiments of the power supply and backup network, the HVDC bus system includes: one or more HVDC buses.

In some exemplary embodiments of the power supply and backup network, in response to a determination that the HVDC bus system includes a plurality of HVDC buses, each of the plurality of HVDC buses is connected to a group of the medium-low voltage power distribution system, the high-voltage battery backup power system and the power distribution system, and the plurality of HVDC buses are connected in parallel.

By means of the above-mentioned network apparatus, the power supply and backup network includes a medium-low voltage power distribution system, a high-voltage battery backup power system, a power distribution system, and an HVDC bus system. The medium-low voltage power distribution system is connected to the power distribution system by means of the HVDC bus system, while the high-voltage battery backup power system is bypassed on the HVDC bus system. The medium-low voltage power distribution system provides HVDC power to the power distribution system, and the high-voltage battery backup power system provides HVDC backup power to the power distribution system. The above-mentioned power supply and backup network delivers DC power supply and backup by means of the HVDC bus system, featuring relatively stable voltage without directional reversal. Moreover, all chained equipment including the power system and backup power system shares the HVDC bus.

### BRIEF DESCRIPTION OF THE DRAWINGS

The accompanying drawings, which are incorporated into and constitute a part of this specification, illustrate embodiments consistent with the present application and, together with the description, serve to explain the principles of the present application.

To more clearly illustrate the technical solutions in the embodiments of the present application or the related art, the following briefly introduces the accompanying drawings required for describing the embodiments or the related art. It will be apparent to a person skilled in the art that, without creative effort, other drawings may be derived from these accompanying drawings.

FIG. 1 is a schematic diagram showing an architecture of a power system of an existing communication device according to the relevant art relevant to the present application;

FIG. 2 is a first structure block diagram showing a power supply and backup network of a communication device according to some embodiments of the present application;

FIG. 3 is a second structure block diagram showing a power supply and backup network of a communication device according to some embodiments of the present application;

FIG. 4 is a third structure block diagram showing a power supply and backup network of a communication device according to some embodiments of the present application;

FIG. 5 is a fourth structure block diagram showing a power supply and backup network of a communication device according to some embodiments of the present application;

FIG. 6 is a fifth structure block diagram showing a power supply and backup network of a communication device according to some embodiments of the present application;

FIG. 7 is a sixth structure block diagram showing a power supply and backup network of a communication device according to some embodiments of the present application;

FIG. 8 is a seventh structure block diagram showing a power supply and backup network of a communication device according to some embodiments of the present application;

FIG. 9 is an eighth structure block diagram showing a power supply and backup network of a communication device according to some embodiments of the present application;

FIG. 10 is a schematic diagram showing a power supply and backup network for a data center sharing an HVDC bus according to some embodiments of the present application; and

FIG. 11 is a schematic diagram showing a power supply and backup network for a high-level data center sharing an HVDC bus according to some embodiments of the present application.

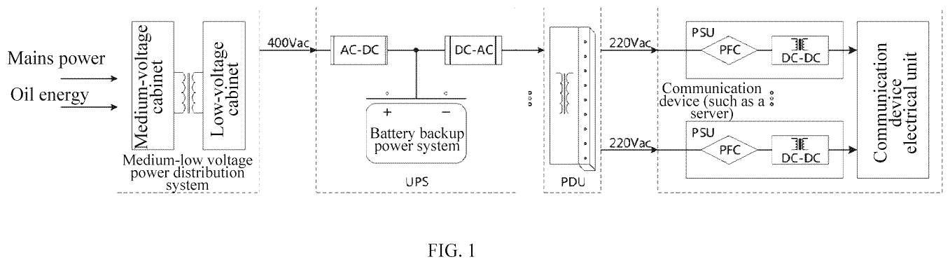

### DETAILED DESCRIPTION

In order to enable a person skilled in the art to better understand the solution of the present application, a clear and complete description of the technical solution of the embodiments of the present application will be provided below in conjunction with the accompanying drawings of the embodiments of the present application, and it is obvious that the embodiments described are only a part of the embodiments of the present application, rather than all the embodiments. Based on the embodiments in the present application, all other embodiments obtained by a person skilled in the art without involving any inventive effort should be within the scope of protection of the present application.

It should be noted that the terms “first”, “second”, and the like in the description and in the claims of the present application and in the above-mentioned drawings are used for distinguishing between similar objects and not necessarily for describing a particular sequential or chronological order. It should be understood that data used in such a manner may be interchangeable where appropriate, whereby the embodiments of the present application described herein may be implemented in orders other than those illustrated or described herein. Furthermore, the terms “include” and “have” as well as any variations thereof are intended to cover non-exclusive inclusion. For example, a process, method, system, product, or device that includes a series of steps or units is not necessarily limited to those expressly listed steps or units but may include other steps or units not expressly listed or inherent to such processes, methods, products, or devices.

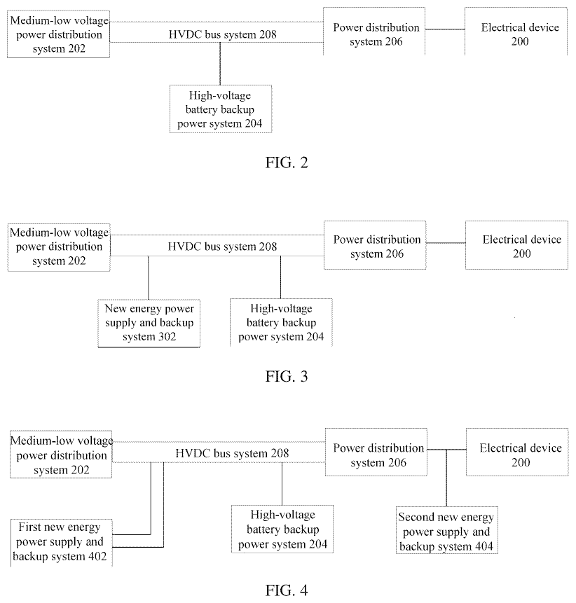

In the present embodiment, a power supply and backup network of a communication device is provided; FIG. 2 is a first structure block diagram showing a power supply and backup network of a communication device according to some embodiments of the present application; as shown in FIG. 2, the power supply and backup network of the communication device includes: a medium-low voltage power distribution system 202, a high-voltage battery backup power system 204, a power distribution system 206 and a high-voltage direct-current (HVDC) bus system 208.

The medium-low voltage power distribution system 202 is connected to the power distribution system 206 by means of the HVDC bus system 208, and the high-voltage battery backup power system 204 is bypassed on the HVDC bus system 208.

The medium-low voltage power distribution system 202 is configured to use input mains power and oil energy backup power to provide HVDC power for the power distribution system 206 by means of the HVDC bus system 208.

The high-voltage battery backup power system 204 is configured to provide HVDC backup power for the power distribution system 206 by means of the HVDC bus system 208.

The power distribution system 206 is configured to distribute, to a connected electrical device 200, the HVDC power transmitted on the HVDC bus system 208.

By means of the above-mentioned network apparatus, the power supply and backup network includes a medium-low voltage power distribution system, a high-voltage battery backup power system, a power distribution system, and an HVDC bus system.

The medium-low voltage power distribution system is connected to the power distribution system by means of the HVDC bus system, while the high-voltage battery backup power system is bypassed on the HVDC bus system. The medium-low voltage power distribution system provides HVDC power to the power distribution system, and the high-voltage battery backup power system provides HVDC backup power to the power distribution system. The above-mentioned power supply and backup network delivers DC power supply and backup by means of the HVDC bus system, featuring relatively stable voltage without directional reversal. Moreover, all chained equipment including the power system and backup power system shares the HVDC bus, which effectively reduces complexity of a power supply line, makes networking simple and easy to expand, facilitates unit system interaction and management, and reduces energy conversion stages in the main power trunk. For instance, it eliminates the AC-DC (alternating current to direct current) to DC-AC (inversion) converters of UPS, isolation transformers of PDU, rectifier circuits at communication device input ports, PFCs, and the like, thereby significantly decreasing energy loss. Therefore, the problem of large energy loss and the like caused by multi-stage conversion in an electric energy transmission path of a power system may be solved, and the effect of reducing the energy loss in the electric energy transmission path of the power system may be achieved.

In the present embodiment, the electrical devices connected to the power distribution system may include, but is not limited to, communication devices including data centers, data storage devices, databases, and the like. The communication device is an electrical terminal device unit, and may include, but is not limited to, electronic devices such as servers, switches, storage servers, base stations, and the like.

In the present embodiment, the medium-low voltage power distribution system directly outputs HVDC power through isolation conversion technology, flexible power transformation technology, or other conversion technologies using mains power and oil energy backup power, eliminating a ACDC and DCAC conversion link of a bypass backup power design of the high-voltage battery backup power system, and providing a design foundation and favorable conditions for achieving energy efficiency, carbon reduction, and low PUE (Power Usage Effectiveness). The medium-low voltage power distribution system is an electrical equipment that converts high-voltage grid electricity into stable DC voltage values that conform to high-voltage DC standards and specifications. The medium-low voltage distribution system is composed of a medium-voltage cabinet, a low-voltage cabinet, a transformer and a converter.

The high-voltage battery backup power system is configured to be bypassed on a shared HVDC bus to provide centralized backup power for the electrical device of the data center (such as a server). The high-voltage battery backup power system includes, but is not limited to, a backup power system composed of batteries, and a high-voltage energy storage backup power system composed of other energy storage apparatuses. Power conversion and main control management of the high-voltage battery backup power system are constituted by charge-discharge conversion, metering and control, communication units, and the like. It is composed of high-voltage battery matrix, battery patrol inspection and Battery Management System (BMS).

In the present embodiment, the high-voltage battery backup power system also shares the HVDC bus system, and by eliminating the ACDC and DCAC conversion link, the high-voltage battery backup power system reduces the number of main circuit converter conversion stages, decreases main circuit power losses, achieves low PUE values, and facilitates energy conservation, emission reduction, and green low-carbon operation.

In the present embodiment, the power distribution system may include, but is not limited to, PDUs and their combined configurations forming power distribution units. These units not only distribute the HVDC power from the power transformation, power distribution and backup power system and high-voltage battery backup power system to various electrical devices, but also allocate the HVDC power transmitted to the electrical device to individual electrical units within each device. Different PDU configurations and combinations may form different power distribution architectures, enabling redundant power supply and backup systems, dual-bus dual-backup shared systems, multi-bus heterogeneous backup systems, and the like.

The PDU is short for power distribution unit, which includes but is not limited to dual-bus combinations for power distribution to the communication device, and enables flexible single-bus, dual-bus, or multi-bus configuration arrangements. Individual PDU units include, but are not limited to, PDUs with energy metering capabilities and PDUs incorporating circuit breakers or other disconnection protection devices. The PDU serves to interconnect the power supply and backup device with electrical devices while sharing the HVDC bus. They conform to HVDC-relevant certification standards.

In some exemplary embodiments, the medium-low voltage power distribution system is configured to charge the high-voltage battery backup power system in the event of normal power supply; and the high-voltage battery backup power system is configured to discharge the HVDC bus system in the event of abnormal power supply in the medium-low voltage power distribution system.

In the present embodiment, the high-voltage battery backup power system is bypassed on the HVDC bus system to provide backup power for the entire data center or other electrical facilities; in the event of abnormal power supply of the medium-low voltage power distribution system, the medium-low voltage power distribution system is disconnected to release the energy of the high-voltage battery backup power system to the HVDC bus system, so as to ensure the normal operation of the entire data center or other electrical facilities for a certain repair time and ensure the reliable operation of the electrical device.

In some exemplary embodiments, the high-voltage battery backup power system may include, but is not limited to, being configured to perform voltage fluctuation smoothing on the HVDC bus system.

In the present embodiment, the primary function of the high-voltage battery backup power system is centralized backup power supply for the electrical device, while concurrently possessing shared HVDC bus voltage fluctuation smoothing functionality to maintain the shared HVDC bus voltage within a certain range, thereby ensuring relatively stable power input for the communication device.

In the present embodiment, during the energy discharge process of the high-voltage battery backup power system, the high-voltage battery backup power system, may either jointly form a power loss hold backup power system with the large-scale new energy power supply and backup system (i.e., the first new energy power supply and backup system), jointly form a power loss hold backup power system with an energy storage warehouse of a bidirectional feed system, jointly form a power loss hold backup power system with a local new energy power supply and backup system (i.e., the second new energy power supply and backup system), or simultaneously form a power loss hold backup power system with the two new energy power supply and backup systems and the energy storage warehouse of the bidirectional feed system, thereby achieving a natural self-expansion capability of the centralized high-voltage battery backup power system, ensuring normal and stable operation of a data center, providing more ample time for fault resolution and emergency repairs, and guaranteeing high-reliability operation of data centers or other electrical facilities and systems. Even in the event that the bidirectional feed system's power grid mains power provides reliable connected power supply, the normal operation of the communication device in the data center may be achieved without power loss.

In the present embodiment, during the energy storage process of the high-voltage battery backup power system, either HVDC charging output from the main circuit of the medium-low voltage power distribution system or trickle charging energy storage from the large-scale new energy power supply and backup system may be received, achieving local energy storage in the event of sufficient new energy. Trickle charging energy storage from the local new energy power supply and backup system may also be received, achieving local energy storage when local new energy is sufficient. Or, when there is a bidirectional feed system, energy transfer from energy storage warehouse of bidirectional feed system may be received. The energy storage process of the bidirectional feed system's warehouse is similar to that of the high-voltage battery backup power system, which stores excess new energy in the warehouse in the event of surplus new energy, or even feeds back to the power grid for grid-connected power generation. This rationally utilizes new energy to achieve lower PUE and achieve low-carbon green sharing.

In some exemplary embodiments, FIG. 3 is a second structure block diagram showing a power supply and backup network of a communication device according to some embodiments of the present application, as shown in FIG. 3, the power supply and backup network may further include, but is not limited to: a new energy power supply and backup system 302, where the new energy power supply and backup system is connected to the HVDC bus system; the new energy power supply and backup system is configured to use the input new energy to provide an HVDC power for the power distribution system or the HVDC backup power for the power distribution system by means of the HVDC bus system.

In the present embodiment, the input new energy may include but is not limited to photovoltaic, wind turbine, optical energy and other energy.

In the present embodiment, the power supply and backup network includes a medium-low voltage power distribution system, a new energy power supply and backup system and a high-voltage battery backup power system provides a shared HVDC bus power supply and backup input for a communication device (an electrical facility or an electrical unit) via an energy distribution metering and management control system by means of PDU and a combination form thereof.

In some exemplary embodiments, FIG. 4 is a third structure block diagram showing a power supply and backup network of a communication device according to some embodiments of the present application, as shown in FIG. 4, the new energy power supply and backup system 302 may further include, but is not limited to: a first new energy power supply and backup system 402 and a second new energy power supply and backup system 404, where the first new energy power supply and backup system is deployed at a remote end of the electrical device and the second new energy power supply and backup system is deployed locally at the electrical device.

In the present embodiment, the first new energy power supply and backup system and the second new energy power supply and backup system may include, but is not limited to, being deployed at different locations. The first new energy power supply and backup system is deployed at a remote end of the electrical device, and may be referred to as a large-scale new energy power supply and backup system; and the second new energy power supply and backup system is deployed locally at the electrical device, and may be referred to as a local new energy power supply and backup system.

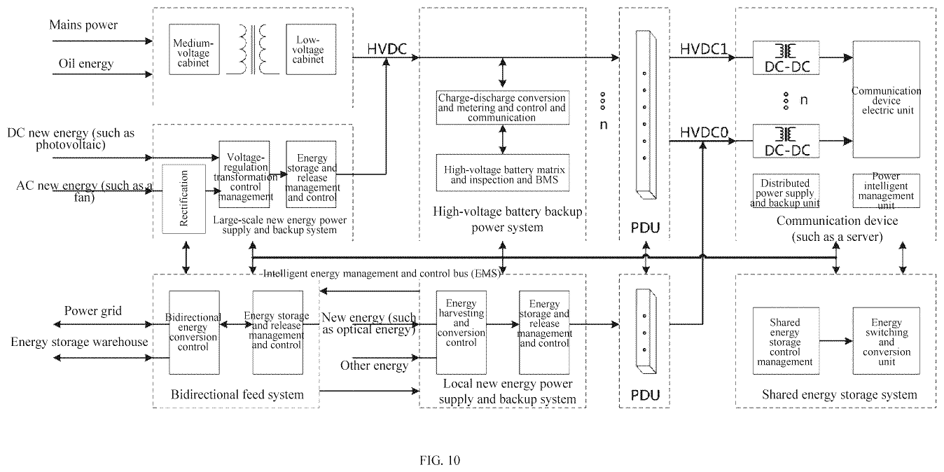

As shown in FIG. 10, the large-scale new energy power supply and backup system converts DC new energy (such as photovoltaic) and/or AC new energy (such as a fan) to HVDC power output through power transformation technology. The DC new energy is directly processed by a voltage-regulation transformation control management unit to generate the HVDC power which meets the requirements of the power system. The conversion unit is a DC input and DC output DC converter. After being rectified by the rectification unit, the AC new energy needs to be processed by the voltage-regulation transformation control management unit to generate the HVDC power which meets the requirements of the power system. An energy storage and release management and control performs three primary functions: internally storing refined DC electrical power; externally supplying power to the HVDC bus; and storing surplus energy to the energy storage warehouse by means of the bidirectional feed system.

The local new energy power supply and backup system is completed by an energy collection apparatus, a power conversion apparatus, and a control module to collect and convert new or other clean energy, and is controlled by an energy storage and release management and control unit for managing the storage, release, and regulation of collected electrical energy.

The local new energy power supply and backup system of the application converts new energy sources (such as optical energy) or other energy sources (such as wind energy) into the HVDC power through energy collection and conversion apparatuses and power transformation technologies, thereby charging energy storage apparatuses within the local new energy power supply and backup system while supplying power and backup energy storage for both HVDC shared bus electrical devices and functional units. The new energy source or other energy sources include one path or two paths or multiple paths as the input of a local new energy power supply and backup system. The energy storage apparatus includes, but is not limited to, an energy storage device consisting of batteries. The electrical devices and functional units include, but are not limited to supporting HVDC power inputs.

The local new energy power supply and backup may be used as the parallel expansion redundancy of the high-voltage battery backup power system, and may be expanded for the capacity of the high-voltage battery backup power system under a fault condition of the medium-low voltage power distribution system.

The local new energy power supply and backup may be used as the parallel expansion redundancy of the large-scale new energy power supply and backup, and may be converted into the large-scale new energy power supply and backup when under a condition that local new energy power supply and backup has insufficient power.

The local new energy power supply and backup may also be used as a power source of the bidirectional feed system, which is configured to transfer the surplus energy of the local new energy power supply and backup system to the bidirectional feed system, the energy storage warehouse and/or the power grid via feeding during the period when the overall energy consumption of the electrical device of the data center is low.

The local new energy power supply and backup system may accept redundant parallel connection with the bidirectional feed system, which is configured such that during periods of high overall energy consumption by the electrical device of the data center, the bidirectional feed system and energy storage warehouse participate in power supply to the electrical device of the data center to achieve valley storage for peak usage. The bidirectional feed system and power grid may additionally participate in powering the electrical device of the data center, thereby adding a one-path mains power redundancy and enhancing the data center's power supply with high redundancy and reliability.

In the present embodiment, the new energy used by the first new energy power supply and backup system may include, but is not limited to, DC new energy (such as photovoltaic), AC new energy (such as a fan), and the like. The new energy used by the first new energy power supply and backup system may include, but is not limited to, optical energy, other energy, and the like.

In some exemplary embodiments, the first new energy power supply and backup system may include, but is not limited to, being used as mutually redundant power systems with the medium-low voltage power distribution system; and the first new energy power supply and backup system may include, but is not limited to, being used as mutually redundant backup power systems with the high-voltage battery backup power system.

In the present embodiment, the large-scale new energy power supply and backup system cooperates with the medium-low voltage power distribution system to provide HVDC power supply and backup for a data center or other electrical facilities.

In the present embodiment, the large-scale new energy power supply and backup system is used as either a data center auxiliary power system which is mutually redundant with the medium-low voltage power distribution system, a backup power system of the data center which is mutually redundant with the high-voltage battery backup power system, and a constant-current and trickle energy storage system for energy storage and replenishment of the high-voltage battery backup power system.

In some exemplary embodiments, in the event that the energy in the first new energy power supply and backup system is higher than a first threshold, it may include, but is not limited to, the first new energy power supply and backup system being used as a primary power supply source for the electrical device, and it may include, but is not limited to, using the medium-low voltage power distribution system as a secondary power supply source for the electrical device.

In the present embodiment, the large-scale new energy power supply and backup system is used as a power supply system, and a multi-loop control auxiliary intelligent management and control bus with constant-voltage and constant-current or constant power is used for real-time control, so as to ensure that the large-scale new energy power supply and backup system, when the energy is sufficient therein, is used as a primary power supply source for a data center, and a medium-low voltage power distribution system is used as a secondary power supply source for the data center. When the energy of large-scale new energy power supply and backup system is sufficient, it may provide HVDC power for the data center or other electrical facilities, and the medium-low voltage power distribution system is used as a redundant on-line backup power device; when the energy of the large-scale new energy power supply and backup system reaches the backup power energy threshold, the system is automatically converted to the backup power system, and the medium-low voltage power distribution system acts as the main power.

In the present embodiment, the large-scale new energy power supply and backup system is used as the backup power system, the large-scale new energy power supply and backup system and the high-voltage battery backup power system are mutually redundant, and the large-scale new energy power supply and backup system effectively expands the capacity of the high-voltage battery backup power system; and in the event of the same scale and the same requirements of the data center, the capacity of the high-voltage battery backup power system may be smaller, the high reliability of the data center may be ensured, and at the same time, the backup power space and cost may be reduced, and the maintenance difficulty may be reduced.

In some exemplary embodiments, the first new energy power supply and backup system may further include, but is not limited to, being configured to perform trickle charging energy storage for the high-voltage battery backup power system.

In the present embodiment, the large-scale new energy power supply and backup system is used as a constant-current and trickle energy storage system to implement energy storage and replenishment for the high-voltage battery backup power system, and constant-current mode control and trickle mode control are adopted to achieve energy localized reserve and replenishment in the event of sufficient new energy for the large-scale new energy power supply and backup system, so as to rationally utilize new energy to achieve lower PUE and achieve low-carbon green HVDC bus power supply and backup architecture.

In some exemplary embodiments, the second new energy supply and backup power system may, but is not limited to, be a mutually redundant power system with the medium-low voltage power distribution system. The second new energy power supply and backup system may, but is not limited to, be a mutually redundant backup power system with the high-voltage battery backup power system. The second new energy power supply and backup system may further, but is not limited to, be a mutually redundant backup power systems with the distributed power supply and backup unit deployed within the electrical device.

In the present embodiment, the local new energy power system is similar to but different from the large-scale new energy power supply and backup system. The local new energy power supply and backup system may both provide HVDC power to the communication device or electrical units sharing the HVDC bus, and may be used as redundant backup power for internal distributed power supply and backup units of the communication device, or electrical units, or independent high-reliability-required communication device nodes. Two or more local new energy power supply and backup systems may form a shared backup system to maintain operation of the communication device during main power abnormalities for extended durations. The communication device (or other electrical facilities) may support HVDC power input or main backup HVDC power input, forming different levels of power supply and backup architectures through different internal architectures. The system may also function as a local constant-current and trickle energy storage system for distributed power supply and backup units within the communication device or the electrical units, further function as a backup power redundancy for the high-voltage battery backup power systems, creating centralized backup with backup redundancy, and also function as a local constant-current and trickle energy storage system for energy storage and replenishment of the high-voltage battery backup power systems.

In some exemplary embodiments, in the event that the energy in the second new energy power supply and backup system is higher than a second threshold, it may include, but is not limited to, using the second new energy power supply and backup system as a primary power supply source for the electrical device, and it may include, but is not limited to, using the medium-low voltage power distribution system and the first new energy power supply and backup system as a secondary power supply source for the electrical device.

In the present embodiment, the local new energy power supply and backup system is used as a power supply system to provide an HVDC power for a communication device or an electrical unit of a data center (or other electrical facilities) or a device node with higher reliability requirements, a multi-loop control auxiliary intelligent management and control bus with constant-voltage and constant-current or constant power is used for real-time control, so as to ensure that the local new energy power supply and backup system, when the energy is sufficient therein, is used as a primary power supply source for the communication device system of the data center or the communication device node with higher reliability requirements; the medium-low voltage power distribution system and the large-scale new energy power supply and backup system are used as a secondary power supply source for the data center communication device or the communication device nodes with high reliability requirements, i.e., acting as redundant on-line backup power, achieving the preferential release and use of local new energy access, and achieving a better green energy-saving benefit; when the energy of the local new energy power supply and backup system reaches a backup power energy threshold, the local new energy power supply and backup system is automatically converted to the backup power system, and the large-scale new energy power supply and backup system and the medium-low voltage power distribution system are respectively used as the first main power and the second main power.

In some exemplary embodiments, the second new energy power supply and backup system may further include, but is not limited to being further configured to perform constant-current or trickle charging energy storage for the high-voltage battery backup power system; or, the second new energy power supply and backup system may further include, but is not limited to being configured to perform constant-current or trickle charging energy storage for the distributed power supply and backup unit deployed within the electrical device.

In the present embodiment, the local new energy power supply and backup system is used as a redundant backup power system of the distributed power supply and backup unit in the communication device or the electrical unit. The local new energy power supply and backup system and the distributed power supply and backup unit in the communication device or the electrical unit are mutually redundant, or it may be considered that the local new energy power supply and backup system effectively expands the capacity of the distributed power supply and backup unit in the communication device or the electrical unit. In the event of the same scale and the same requirements of the data center, the capacity of the distributed power supply and backup unit in the communication device or the electrical unit may be smaller, the high reliability of the data center may be ensured, and at the same time, the backup power space and cost may be reduced, and the maintenance difficulty may be reduced.

In the present embodiment, the local new energy power supply and backup system is used as a constant-current and trickle energy storage system for the distributed power supply and backup units in the communication device or the electrical unit, and implements energy storage and replenishment for the distributed power supply and backup units in the communication device or the electrical unit, and constant-current mode control and trickle mode control are adopted to achieve energy localized reserve and replenishment in the event of sufficient new energy for the local new energy power supply and backup system, so as to rationally utilize new energy to achieve lower PUE and achieve low-carbon green HVDC bus power supply and backup architecture.

In the present embodiment, the local new energy power supply and backup system is used as a redundant backup power system of the high-voltage battery backup power system, and the local new energy power supply and backup system and the high-voltage battery backup power system are mutually redundant, or it may be considered that the local new energy power supply and backup system effectively expands the capacity of the high-voltage battery backup power system; and in the event of the same scale and the same requirements of the data center, the capacity of the high-voltage battery backup power system may be smaller, the high reliability of the data center may be ensured, and at the same time, the backup power space and cost may be reduced, and the maintenance difficulty may be reduced.

In the present embodiment, the local new energy power supply and backup system is used as a constant-current and trickle energy storage system of the high-voltage battery backup power system to implement energy storage and replenishment for the high-voltage battery backup power system, and constant-current mode control and trickle mode control are adopted to achieve energy localized reserve and replenishment in the event of sufficient new energy for the local new energy power supply and backup system, so as to rationally utilize new energy to achieve lower PUE and achieve low-carbon green HVDC bus power supply and backup architecture.

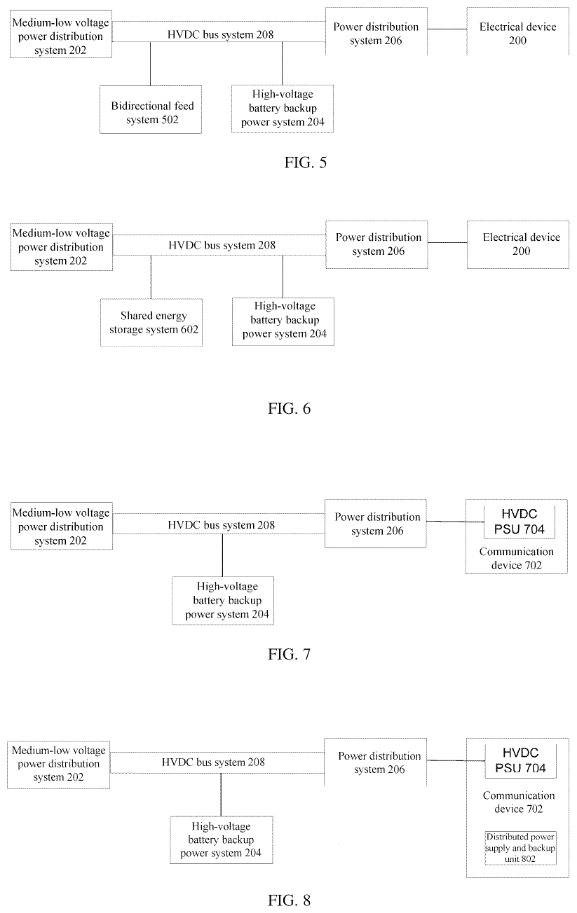

In some exemplary embodiments, FIG. 5 is a fourth structure block diagram showing a power supply and backup network of a communication device according to some embodiments of the present application; as shown in FIG. 5, the power supply and backup network may further include, but is not limited to, a bidirectional feed system 502, where the bidirectional feed system is configured to store valley period surplus energy from the new energy power supply and backup system into an energy storage warehouse, and supply power to a power grid after the energy storage warehouse is fully charged; and the bidirectional feed system is further configured to provide the energy stored in the energy storage warehouse or the energy provided by the power grid to the electrical device during peak power consumption period of the electrical device.

As shown in FIG. 10, the bidirectional feed system accomplishes bidirectional energy transmission through the energy bidirectional conversion control unit, while the energy storage and release management and control unit performs energy flow management, serving as a subordinate unit under the intelligent energy management and control bus.

The bidirectional feed system is configured to control and collect the surplus energy of the large-scale new energy power supply and backup system and the local new energy power supply and backup system for storage in the energy storage warehouse and/or feedback to the power grid, and to release energy from the energy storage warehouse and/or the power grid to the HVDC bus of the system of the present application when the large-scale new energy power supply and backup system and the local new energy power supply and backup system are insufficient to support the operation of the electrical device. To achieve “valley storage for peak usage” of surplus energy, enabling full and rational utilization of new green energy sources while minimizing waste of collected energy. The bidirectional feed system includes, but is not limited to, one stand-alone energy storage warehouse, which includes, but is not limited to, a DC energy storage apparatus system composed of batteries. The bidirectional feed system includes, but is not limited to, support for a one-path new energy system surplus feed. The bidirectional feed system is a bidirectional system having a core functional feature of collecting and storing surplus energy from the new energy power supply and backup system during valley operation periods of an electrical device into the energy storage warehouse, with additional surplus energy being fed back to the grid for grid-connected power generation; during peak operation periods of the electrical device when the new energy power supply and backup system is insufficient, the energy storage warehouse supplements power to the HVDC bus equipment through the bidirectional feed system.

In the present embodiment, the bidirectional feed system, which may include, but is not limited to, being configured to control the storage and release of surplus energy in the power supply and backup network, being stored to the energy storage warehouse and/or the power grid, and the HVDC bus, which releases the energy storage warehouse and/or the power grid to the power supply and backup network, being configured to operate as the electrical device. To achieve “valley storage for peak usage” of surplus energy, enabling full and rational utilization of new green energy while minimizing waste of collected energy.

In the present embodiment, the bidirectional feed system stores valley period surplus energy. When the large-scale new energy power supply and backup system and/or the local new energy power supply and backup system generate energy surplus during valley operation periods of the electrical device of the data center, through the predictive analysis by the intelligent management and control bus, it is determined whether to store the surplus in the energy storage warehouse and/or power grid, in some embodiments, to local energy storage systems such as the energy storage warehouse. When the energy storage warehouse reaches full capacity, excess energy may then be fed back to the power grid. To ensure valley-period storage and conversion of green new energy collected by the large-scale new energy power supply and backup system and/or local new energy power supply and backup system, thereby creating peak-period energy storage without wasting surplus energy.

In the present embodiment, the bidirectional feed system releases stored energy during peak periods. The surplus energy in the energy storage warehouse is discharged during predicted peak operational periods of the electrical device of the data center by the intelligent management and control bus system. This method both conserves mains power supply energy and reduces energy waste, achieving low-carbon operations with reduced PUE, while ensuring stable and highly reliable operation of the large-scale new energy power supply and backup system and/or local new energy power supply and backup system.

In the present embodiment, where the bidirectional feed system interfaces with the power grid, it may also be designed as a bidirectional device, equivalent to adding a mains power system, greatly improving the reliability of the overall power supply and backup network. During valley operation periods of the electrical device of the data center, when the energy storage warehouse reaches full capacity, the power grid is fed. During peak operation periods of the electrical device of the data center, this system may function as a one-path mains power supply, and an auxiliary mains power backup that provides power supply support during main power anomalies of the mains power, thereby further enhancing the reliability of the power supply and backup network of the data center while ensuring sustained data service continuity and security.

In some exemplary embodiments, FIG. 6 is a fifth structure block diagram showing a power supply and backup network of a communication device according to some embodiments of the present application; as shown in FIG. 6, the power supply and backup network may further include, but is not limited to: a shared energy storage system 602, where the shared energy storage system is connected to the HVDC bus system; the shared energy storage system is configured to store energy to the distributed power supply and backup unit deployed on the electrical device or release energy to the distributed power supply and backup unit deployed on the electrical device by means of the HVDC bus system.

As shown in FIG. 10, the shared energy storage system includes a shared energy storage control management and an energy switching and conversion unit.

The shared energy storage system is configured to control energy storage sharing and on-demand release of the distributed power supply and backup unit of the communication device, where the distributed power supply and backup unit stores or releases energy by means of a shared bus.

The shared energy storage system remains silent or stabilizes HVDC bus voltage under non-power device or electrical device abnormal states. The shared energy storage system, in a power device failure state, determines the allocation of shared backup power based on the importance level of fault nodes.

In the present embodiment, the shared energy storage system is configured to enable sharing of the stored energy of the distributed power supply and backup unit of the communication device. Energy is stored or discharged to the distributed power supply and backup by means of a shared HVDC bus.

In some exemplary embodiments, the shared energy storage system may include, but is not limited to, being configured to allocate distributed power supply and backup units for providing backup power in the event of a power system failures within the power supply and backup network; and the shared energy storage system may further include, but is not limited to, being configured to switch the backup power system to the distributed power supply and backup unit deployed on the electrical device before the energy stored in the system configured for backup power in the power supply and backup network being discharged to a limiting threshold in the event of the power system failures in the power supply and backup network.

In the present embodiment, the shared energy storage system remains silent or allocates configured distributed power supply and backup units to regulate HVDC bus voltage under non-power supply device or electrical device abnormal states.

In the present embodiment, the shared energy storage system, during power supply device abnormal or failure states, determines the allocation of which and how many distributed power supply and backup units to provide backup support based on the importance level of fault nodes, ensuring sufficient and reliable backup power during abnormal power supply.

In the present embodiment, the shared energy storage system may be configured such that during data center power supply main circuit failure states, before energy discharge reaches limit points in the large-scale new energy power supply and backup system and/or local new energy power supply and backup system and/or the bidirectional feed system, it proactively prepares for energy switching and conversion based on the intelligent management and control bus system's analytical judgments and predetermined high-reliability equipment node requirements, standing ready to relay backup power assurance with the power, new energy backup, energy storage warehouse, and bidirectional feed system to guarantee communication device data service continuity and security.

In some exemplary embodiments, FIG. 7 is a sixth structure block diagram showing a power supply and backup network of a communication device according to some embodiments of the present application, as shown in FIG. 7, an electrical device may include, but is not limited to: a communication device 702, where an HVDC Power Supply Unit (HVDC PSU) 704 is deployed in the communication device, and the HVDC PSU includes a power supply conversion apparatus that conforms to DC input.

In the present embodiment, the communication device is an electrical terminal device unit, and includes, but is not limited to, electronic devices such as servers, switches, storage servers, base stations, and the like. The communication device internally contains a DCDC conversion unit, referred to herein as an HVDC PSU, which includes, but is not limited to, a power supply conversion apparatus that conforms to the DC input; the communication device may also internally contain a distributed power supply and backup unit or include a self-backup power and self-redundant PSU.

In some exemplary embodiments, the power supply conversion apparatus may include, but is not limited to: a DCDC isolation converter, a self-backup power DCDC isolation converter, or a self-redundant DCDC isolation converter.

In the present embodiment, the communication device internally contains an HVDC PSU, and the HVDC PSU may include, but is not limited to, a DCDC isolation converter, a self-backup power DCDC isolation converter, and a self-redundant DCDC isolation converter, and the input thereof is an HVDC, and the output thereof is a low-voltage DC bus (such as 12 V, 48 V, and the like.); HVDC PSU only supports DC input, and there is no rectification unit, PFC unit on the power supply main circuit. It is beneficial to energy conservation, emission reduction, and green low-carbon operation by reducing the number of transmission conversion stages and main circuit loss of a main circuit converter.

In some exemplary embodiments, FIG. 8 is a seventh structure block diagram showing a power supply and backup network of a communication device according to some embodiments of the present application, as shown in FIG. 8, a communication device in the power supply and backup network may further include, but is not limited to, a distributed power supply and backup unit 802, where the distributed power supply and backup unit is configured to provide backup power to the communication device.

In the present embodiment, a distributed power supply and backup unit may be included inside the communication device, where the distributed power supply and backup unit provides backup power for a single-node communication device, during HVDC PSU input abnormalities or unit failures, these units deliver short-term backup power to both the electrical units and other units in the communication device, thereby securing essential operational time for data processing, task execution, fault analysis and warning functions to facilitate either repair or backup switching procedures, while ensuring node equipment data security without loss or interruption.

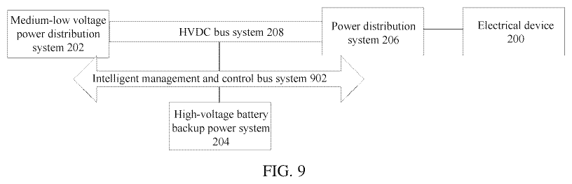

In some exemplary embodiments, FIG. 9 is an eighth structure block diagram showing a power supply and backup network of a communication device according to some embodiments of the present application, as shown in FIG. 9, the power supply and backup network may further include, but is not limited to: an intelligent management and control bus system 902, where the intelligent management and control bus system is connected to all functional systems included in the power supply and backup network; and the intelligent management and control bus system is configured to monitor all the functional systems, and regulate and control the power system and the backup power system of the power supply and backup network according to a working state of all the functional systems.

The intelligent management and control bus system is collectively formed by the energy control components of each functional subsystem and uniformly coordinated by the power intelligent management unit within the communication device to accomplish energy flow management and control for the system according to the present application.

The intelligent management and control bus system is configured as a system for monitoring each functional unit in real time, collecting and processing state information, and maintaining real-time interaction with a control and management unit of each large-functional system. To ensure the operation of the overall system in the state of optimal energy efficiency and optimal configuration control and early warning in the failure state, to achieve intelligent control and management and the state of the power system is controllable and visible.

In the present embodiment, the intelligent management and control bus system may be configured as a bus control system for monitoring state information collection and processing capacity of each functional unit, maintaining real-time interaction with the control and management units of each major functional system, ensuring optimal state operation of the overall system and optimal configuration control and early warning in a fault state, achieving diversified shared backup, improving the flexibility and high reliability of the overall HVDC bus system, achieving energy distribution according to demand through integrated control and management, rationally reserving and releasing new energies, achieving green energy saving in a data center, and achieving low-PUE and low-carbon emission in the data center, which provides a design reference for foundation construction of a new generation of large data center.

In some embodiments, a power supply and backup network for a data center sharing an HVDC bus is provided, FIG. 10 is a schematic diagram showing a power supply and backup network for a data center sharing an HVDC bus according to some embodiments of the present application, and as shown in FIG. 10, the power supply and backup network for a data center sharing an HVDC bus includes: seven basic units: a medium-low voltage power distribution system, a large-scale new energy power supply and backup system, a high-voltage battery backup power system, PDUs and a communication device, a local new energy power supply and backup system with PDUs, a bidirectional feed system, and a shared energy storage system. The schematic diagram showing the power supply and backup network for a data center sharing an HVDC bus is a simplified schematic block diagram, including but not limited to the above-mentioned seven basic units, along with different levels of power supply and backup systems of the data center formed by combinations of these basic units, including but not limited to conventional modification means such as additions, deletions, interleaving, or cascading of these seven basic unit systems according to practical requirements.

HVDC is short for high-voltage direct current, which provides DC power supply with relatively stable voltage and no directional reversal. Its voltage range covers 48 Vdc and higher DC voltages, including but not limited to typical values such as 240 Vdc, 336 Vdc, 380 Vdc, and 400 Vdc. In the above-mentioned power supply and backup network for a data center sharing an HVDC bus, all basic functional unit systems share the high-voltage direct current (HVDC) bus, thereby reducing non-essential conversion stages, isolation transformers, rectifying units, PFC units, EMC (Electromagnetic Compatibility) units, and the like. The respective system functions are as follows:
the medium-low voltage power distribution system directly outputs HVDC power through isolation conversion technology, flexible power transformation technology, or other conversion technologies using mains power and oil energy backup power. The mains power serves as the power grid, which includes but is not limited to single-circuit access; mains power and oil energy include but are not limited to generators and similar power generation equipment, and includes but is not limited to single-unit access; HVDC nominal values conform to global and/or Chinese high-voltage direct current standards and specifications, including but not limited to values such as 240 Vdc and 336 Vdc. The isolation conversion technology serves the purposes of isolating the HVDC bus from a high-voltage grid, and of converting high-voltage grid electricity into stable DC voltage values that conform to high-voltage direct current standards and specifications. The installed capacity of the medium-low voltage power distribution system approaches or fully covers a total peak power demand of the data center or other electrical facilities it supplies.

The medium-low voltage power distribution system included in the above-mentioned power supply and backup network directly outputs HVDC, effectively resolving issues associated with AC output from medium-low voltage power distribution systems, including the provision of AC bus requirements and the need for multiple conversions to satisfy different types of device input demands. The medium-low voltage power distribution system outputs HVDC, directly forms an HVDC bus, and a data center system device shares the HVDC bus.

The large-scale new energy power supply and backup system converts the DC new energy (such as photovoltaic) and/or AC new energy (such as a fan) into HVDC power through a power transformation technology, thereby charging energy storage apparatuses within the system while supplying power and backup energy storage for both HVDC shared bus electrical devices and functional units. The DC new energy and/or AC new energy includes one path or two paths or multiple paths as the input of a large-scale new energy power supply and backup system; the energy storage apparatus includes, but is not limited to, an energy storage device consisting of batteries; examples of the electrical devices and functional units include, but are not limited to, those that support HVDC power inputs.

The large-scale new energy power supply and backup system and the medium-low voltage power distribution system are parallel redundant, and the power control of the large-scale new energy power supply and backup system includes but is not limited to the large double-loop control composed of the constant-voltage and constant-current or constant-power self-control inner loop control and the intelligent energy management and control bus outer loop control. The constant-voltage and constant-current or constant-power self-control inner loop control enables parallel redundant power supply auto-switching between the large-scale new energy power supply and backup system and the medium-low voltage power distribution system. When the installed generation capacity of the large-scale new energy power supply and backup system may sustain the total power demand of an electrical device of the data center, it adopts the default initial voltage constant-voltage power supply mode; when the installed generation capacity of the large-scale new energy power supply and backup system falls below the total power demand of electrical device of the data center, it switches to constant-current power supply mode using a preset default current value based on its own capacity. As the output voltage of the large-scale new energy power supply and backup system decreases and reaches the preset power release limit set according to its capacity, the system transitions to backup power state, whereupon HVDC bus electrical device and functional units are powered by the medium-low voltage power distribution system. The default initial output voltage of the large-scale new energy power supply and backup system is higher than the HVDC power output voltage of the medium-low voltage power distribution system, including but not limited to the large-scale new energy power supply and backup system outputting the default initial output voltage of 360 Vdc, including but not limited to the HVDC power output voltage of the medium-low voltage power distribution system of 336 Vdc. The intelligent energy management and control bus outer loop control is governed by the intelligent management and control bus through predictive intelligent monitoring of all system unit states, with decisions determined by algorithms and real-time states.

The large-scale new energy power supply and backup system may be used as the parallel expansion redundancy of the high-voltage battery backup power system, and is configured to expand the capacity of the high-voltage battery backup power system under the fault condition of medium-low voltage power distribution system.

The large-scale new energy power supply and backup system may be used as a power supply source of the bidirectional feed system, and is configured to transfer the surplus energy of the large-scale new energy power supply and backup system to the bidirectional feed system and the energy storage warehouse and/or the power grid via feeding during the period when the overall energy consumption of the electrical devices of the data center is low.

The large-scale new energy power supply and backup system may accept redundant parallel connection with the bidirectional feed system, and is configured such that during periods of high overall energy consumption by the electrical devices of the data center, the bidirectional feed system and energy storage warehouse participate in power supply to the electrical devices of the data center to achieve valley storage for peak usage, while the bidirectional feed system and power grid may additionally participate in powering the electrical devices of the data center, thereby adding a one-path mains power redundancy and enhancing the data center's power supply with high redundancy and reliability.

The local new energy power supply and backup system converts a new energy (such as optical energy) or other energy (such as wind energy) into HVDC power through energy collection and conversion apparatuses and power transformation technologies, thereby charging energy storage apparatuses within the local new energy power supply and backup system while supplying power and backup energy storage for both HVDC shared bus electrical devices and functional units. The new energy or other energy include one path or two paths or multiple paths as the input of a local new energy power supply and backup system; the energy storage apparatus includes, but is not limited to, an energy storage device consisting of batteries; examples of the electrical devices and functional units include, but are not limited to, those that support HVDC power inputs.

The local new energy power supply and backup system shares the HVDC bus with other systems to establish mutual redundancy, and the power control of the local new energy power supply and backup system includes but is not limited to the large double-loop control composed of the constant-voltage and constant-current or constant-power self-control inner loop control and the intelligent energy management and control bus outer loop control. The constant-voltage and constant-current or constant-power self-control inner loop control enables parallel redundant power supply auto-switching between the local new energy power supply and backup system, the local new energy power supply and backup system and the medium-low voltage power distribution system. When the installed generation capacity of the local new energy power supply and backup system may sustain the total or single node power demand of an electrical device of the data center, it adopts the default initial voltage constant-voltage power supply mode; when the installed generation capacity of the local new energy power supply and backup system falls below the total or single node power demand of electrical device of the data center, it switches to constant-current power supply mode using a preset default current value based on its own capacity. As the output voltage of the local new energy power supply and backup system decreases and reaches the preset power release limit set according to its capacity, the system transitions to backup power state, whereupon HVDC bus electrical device and functional units are powered by the large-scale new energy power supply and backup system or the medium-low voltage power distribution system. The default initial voltage output by the local new energy power supply and backup system is higher than the HVDC power output voltage of the large-scale new energy power supply and backup system and the medium-low voltage power distribution system, including but not limited to the default initial voltage output by the local new energy power supply and backup system being 384 Vdc, and the HVDC power output voltages of the large-scale new energy power supply and backup system and the medium-low voltage power distribution system being 360 Vdc and 336 Vdc, respectively. The intelligent energy management and control bus outer loop control is governed by the intelligent management and control bus through predictive intelligent monitoring of all system unit states, with decisions determined by algorithms and real-time states.

The local new energy power supply and backup system may be used as the parallel expansion redundancy of the high-voltage battery backup power system and expand the capacity of the high-voltage battery backup power system under the fault condition of medium-low voltage power distribution system.

The local new energy power supply and backup system may be used as the parallel expansion redundancy of the large-scale new energy power supply and backup system, and may be converted into the large-scale new energy power supply and backup system when the local new energy power supply and backup system has insufficient power supply.

The local new energy power supply and backup system may also be used as a power supply source of the bidirectional feed system, and is configured to transfer the surplus energy of the local new energy power supply and backup system to the bidirectional feed system and the energy storage warehouse and/or the power grid via feeding during the period when the overall energy consumption of the electrical devices of the data center is low.

The local new energy power supply and backup system may accept redundant parallel connection with the bidirectional feed system, and is configured such that during periods of high overall energy consumption by the electrical devices of the data center, the bidirectional feed system and energy storage warehouse participate in power supply to the electrical devices of the data center to achieve valley storage for peak usage, while the bidirectional feed system and power grid may additionally participate in powering the electrical devices of the data center, thereby adding a one-path mains power redundancy and enhancing the data center's power supply with high redundancy and reliability.

In the above-mentioned power supply and backup network, the green new energy power supply and backup system is integrated into the data center power system, and the energy consumption of the data center is huge. Integrating the green new energy power supply and backup system into the data center power system may efficiently apply the new energy, effectively reduce the mains power supply and the load of the medium-low voltage power distribution system, and conform to the green, environment-friendly, low-carbon and low-PUE development strategy. In addition, the green new energy power supply and backup system shares the HVDC bus. Conventional new energy collection, conversion, and grid-connected power generation require multiple conversion stages including rectification, voltage boosting, and inversion for practical application. In contrast, the HVDC bus-sharing architecture of this power supply and backup network enables direct integration of new energy into the HVDC bus for power supply to the communication device after only voltage boosting and regulation, eliminating inversion requirements, thereby reducing new energy system integration losses and achieving more energy-saving, low-loss, and low-carbon green energy power supply.

The above-mentioned green new energy power supply and backup system in the above-mentioned power supply and backup network may also share an HVDC bus for data center backup power capacity expansion, and the energy storage apparatus unit of the green new energy power supply and backup system shares the HVDC bus with the high-voltage backup power system of the data center to form effective capacity expansion for the backup power system of the data center, so as to achieve high-reliability backup power of the data center and reduce volume proportion of centralized high-voltage backup power system of the data center.

The above-mentioned power supply and backup network also implements switchable power supply and backup as a whole in the green renewable energy power supply and backup system, where the system collects renewable energy and stores converted energy in its energy storage apparatuses before connecting to the power supply bus upon meeting supply requirements as determined by the intelligent management and control system. Simultaneously, the energy storage apparatuses share the HVDC bus with the high-voltage backup system, thereby achieving the backup functionality of the green new energy power supply and backup system. It effectively strengthens the functional characteristics of the green new energy power supply and backup system, weakens the functional state of the high-voltage backup power system in the data center, and relieves the pressure of infrastructure construction.

In the above-mentioned power supply and backup network, a large two-loop control of green new energy power supply and backup system, an inner loop control of constant-voltage and constant-current constant-power system and the outer loop control of intelligent management and control system are achieved. The effective implementation of control strategies significantly enhances green energy utilization efficiency while improving both control system and data center power supply reliability. Through the incorporation of constant-voltage and constant-current and constant power inner-loop control, the system optimally deploys power supply strategies across local new energy power supply and backup systems, large-scale new energy power supply and backup systems, and medium-low voltage power distribution systems. The local new energy power supply and backup system is prioritized, followed by the large-scale new energy power supply and backup system. Only when the new energy systems lack available energy for HVDC bus supply does the medium-low voltage power distribution system switch from a backup mode to a power mode. This method maximizes green new energy usage, reduces grid power supply pressure, and conforms to low-carbon, low-PUE green environmental strategies.

The above-mentioned power supply and backup network achieves intelligent management and control of the outer loop of the green new energy power supply and backup system. The intelligent management and control system intelligently analyzes and predicts the optimal operating mode of each power supply and backup unit based on the status of each functional unit in the data center power system. This effectively advances the shared HVDC bus power supply and backup system toward deeper green energy efficiency implementation.

The high-voltage battery backup power system is configured to be bypassed on the high-voltage battery backup power system on a shared HVDC bus to provide centralized backup power for the electrical devices of the data center. The backup power system includes, but is not limited to, a backup power system composed of batteries, and a high-voltage energy storage backup power system composed of other energy storage apparatuses, which is referred to as a high-voltage battery backup power system in the present embodiment for the convenience of explanation. It is configured to release the energy of the high-voltage battery backup power system to the shared HVDC bus in the power system fault state, so as to maintain the normal operation of the data center or other electrical facilities for a certain set time. The system is used for smooth sharing of HVDC bus voltage in the normal operation state of the power system. Charging or recharging from the new energy power supply and backup system may also be acceptable.

The high-voltage backup system included in the above-mentioned power supply and backup network employs a shared HVDC bus bypass for backup power, completely eliminating main circuit AC-DC and DC-AC conversion stages, thereby reducing energy losses while simultaneously enhancing both the backup system's reliability and that of the entire power supply and backup network of the data center. This shared HVDC bus bypass architecture facilitates easier backup system capacity expansion. For data centers of equivalent scale, the HVDC bus centralized high-voltage backup system requires smaller capacity, which reduces the backup power scale within the data center, decreases spatial footprint, and ultimately improves the data center's reliability and safety.

The communication device constitutes an electrical terminal device unit, receiving power supply and backup from the other six functional systems, including but not limited to electronic devices such as servers, storage servers, edge servers, switches, routers, base stations, and the like. The communication device is an electrical device unit in a power supply and backup green energy-saving network for a data center sharing an HVDC bus, which supports HVDC power input, and an input HVDC voltage range thereof includes an output voltage range of each power supply and backup network unit on the shared HVDC bus, including but not limited to supporting a double-bus input or a multi-bus input.

The communication device internally contains a DC-DC (Direct Current to Direct Current) conversion unit, which converts the HVDC shared bus voltage to the low voltage value required by each electrical unit in the communication device. The DC-DC conversion unit is an isolation converter, including but not limited to a power supply conversion apparatus that conforms to a DC input or a PSU with a self-backup power and self-redundancy function, where one function is to support an HVDC power input, and the other function is to isolate the HVDC power from low-voltage power.

The distributed power supply and backup unit may be included in the communication device, which provides backup power for the communication device and is the control basis for the shared energy storage system. The unit functions to support the HVDC power input, and has the function of regulating the violent fluctuation of HVDC bus voltage.

The PDU is short for power distribution unit, whose configurations include but are not limited to dual-bus combinations for power distribution to the communication device, enables flexible single-bus, dual-bus, or multi-bus configuration arrangements. Individual PDU units include, but are not limited to, PDUs with energy metering capabilities and PDUs incorporating circuit breakers or other disconnection protection devices. Functionally, they serve to interconnect a power supply and backup device with electrical devices while sharing the HVDC bus, and conform to HVDC-relevant certification standards.

In the above-mentioned power supply and backup network, both PDUs and the communication device share the HVDC bus. This shared HVDC access architecture allows elimination of isolation transformers in PDUs, reducing main circuit conversion losses; removal of rectification and power factor correction stages at the communication device power inputs, decreasing main/branch circuit converter losses; and reduced current conduction losses through HVDC bus sharing. This effectively reduces energy losses while complying with low-carbon green energy efficiency requirements.

Distributed power supply and backup is also deployed in the communication device in the above-mentioned power supply and backup network. The integrated distributed power supply and backup unit in the communication device improves node-level reliability, improves the backup power redundancy, and effectively reduces the capacity required by a centralized high-voltage backup system on the HVDC bus.

A bidirectional feed system is configured to control and collect the surplus energy of the large-scale new energy power supply and backup system and the local new energy power supply and backup system for storage in the energy storage warehouse and/or feedback to the power grid, and to release energy from the energy storage warehouse and/or the power grid to the HVDC bus of the above-mentioned power supply and backup network when the large-scale new energy power supply and backup system and the local new energy power supply and backup system are insufficient to support the operation of the electrical device. To achieve “valley storage for peak usage” of surplus energy, enabling full and rational utilization of new green energy while minimizing waste of collected energy. The bidirectional feed system includes, but is not limited to, one stand-alone energy storage warehouse, which includes, but is not limited to, a DC energy storage apparatus system composed of batteries. The bidirectional feed system includes, but is not limited to, support for a one-path new energy system surplus feed. The bidirectional feed system is a bidirectional system having a core functional feature of collecting and storing surplus energy from the new energy power supply and backup system during valley operation periods of an electrical device into the energy storage warehouse, with additional surplus energy being fed back to the power grid for grid-connected power generation; during peak operation periods of the electrical device when the new energy power supply and backup system is insufficient, the energy storage warehouse supplements power supply to the HVDC bus equipment through the bidirectional feed system.

In the above-mentioned power supply and backup network, the bidirectional feed system controls the surplus energy storage from new energy to achieve valley storage for peak usage. The bidirectional feed system is configured to optimally utilize new energy potential by storing surplus energy from the new energy system during valley data center operation periods through a shared HVDC bus into both the bidirectional feed system and energy storage warehouse, and releasing power from the bidirectional feed system and energy storage warehouse through the shared HVDC bus during peak data center operation periods. This effectively advances the shared HVDC bus power supply and backup green energy-saving system toward reasonable recycling of surplus energy.

In the above-mentioned power supply and backup network, the bidirectional feed system controls the surplus energy storage from new energy to be fed for grid-connected power generation, and when the bidirectional feed system and the energy storage warehouse are fully charged with energy, there is still a surplus new energy, and the system may convert and feed the remaining surplus energy into the power grid through control by the bidirectional feed system. This effectively achieves in-depth rational utilization of green new energy, minimizes energy waste, and reduces power supply costs for data centers.

In the above-mentioned power supply and backup network, the HVDC bus shared by the bidirectional feed system and the energy storage warehouse is used for data center backup power capacity expansion, and the bidirectional feed system and the energy storage warehouse share the HVDC bus with the high-voltage backup power system of the data center to form effective capacity expansion for the high-voltage backup power system of the data center, so as to achieve high-reliability backup power of the data center and reduce volume proportion of centralized high-voltage backup power system of the data center, effectively weakening the high-voltage backup power system, and reducing the scale cost and difficulty of the basic building of the data center.

A shared energy storage system is configured to control energy storage sharing and on-demand release of the distributed power supply and backup unit of the communication device, where the distributed power supply and backup unit stores or releases energy by means of a shared bus. The shared energy storage system remains silent or regulates HVDC bus voltage under non-power supply device or electrical device abnormal states; the shared energy storage system, in a power supply device failure state, determines the allocation of shared backup power based on the importance level of fault nodes.

The above-mentioned shared energy storage system in the power supply and backup network may achieve reasonable sharing of the backup power; the shared energy storage system is configured to control energy storage sharing and on-demand release of the distributed power supply and backup unit of the communication device, where the distributed power supply and backup unit stores or releases energy by means of a shared HVDC bus. This effectively enhances backup power efficiency, delivering highly reliable backup power while simultaneously reducing backup power capacity requirements.

An intelligent management and control bus system is configured as an intelligent management and control bus system for monitoring each functional unit in real time, collecting and processing state information, and maintaining real-time interaction with a control and management unit of each large-functional system. To ensure the operation of the overall system in the state of optimal energy efficiency and optimal configuration control and early warning in the failure state, to achieve intelligent control and management and the state of the power system is controllable and visible.

The above-mentioned power supply and backup network enhances the intelligence level of data center power network through an intelligent management and control bus system which performs real-time monitoring of each functional unit's communication and control modules via high-speed buses, collects and analyzes status information from all functional system units, and maintains real-time interaction with control management units of major functional systems, which ensures optimal energy efficiency operation of the overall system, provides optimized configuration control and early warning during fault conditions, and achieves intelligent control and management with controllable and visible power system status.

Through the above-mentioned power supply and backup network, all chained equipment in the data center power system shares the HVDC bus, effectively resolving existing issues of complex AC bus and DC bus configurations in conventional data center power systems that hinder equipment connection, expansion, and networking. All chained equipment including power supply devices, backup power devices, and communication devices share the HVDC bus, significantly reducing power line complexity while enabling simplified, scalable networking and facilitating inter-unit system interaction and management.

The above-mentioned power supply and backup network may reduce cascade stages of main power path energy converters. By sharing the HVDC bus across seven fundamental functional system units and equipment in the data center, it eliminates multiple power transformation stages, such as removing AC-DC (alternating current to direct current) to DC-AC (inversion) converters in UPS systems, isolation transformers in PDUs, input rectifier circuits and PFCs in the communication device, thereby effectively reducing energy losses and aligning with low-carbon, low-PUE green environmental principles.

The above-mentioned power supply and backup network also improves the reliability of the power supply and backup network of the data center, and effectively improves the reliability of the data center by various means. The main power and backup network achieves decentralized expansion of high-voltage backup systems for data centers through new energy storage apparatuses, bidirectional feed systems with energy storage warehouses, and distributed backup power, thereby enhancing reliability for data center backup power. It improves reliability for power supply of the data center through shared HVDC buses, dual-buses, multiple buses, diversified power supply connections, and autonomous power supply switching capabilities.

The above-mentioned power supply and backup network further enhances voltage regulation in data center power system, addressing significant voltage fluctuations on power buses of the data center caused by complex network structures and varying power consumption patterns of different electrical devices. Through the large-scale new energy system energy storage apparatus, the local new energy system energy storage apparatus, the bidirectional feed system, the energy storage warehouse, the distributed power supply and backup unit system, a voltage regulation compensation technology of power supply bus backup is used to effectively improve the stability of power supply voltage in the data center.

The above-mentioned power supply and backup network also achieves greening of the power supply energy of the data center, and the power supply and backup network for a data center sharing an HVDC bus is easy to achieve large-scale expansion. Through the large-scale new energy system, the local new energy system, the bidirectional feed system and centralized and discrete expansion of the energy storage warehouse, the problem of the power supply of the large-scale data center may be effectively solved, and the greening of the power supply energy of the data center may be achieved.

In some exemplary embodiments, an HVDC bus system may include, but is not limited to: one or more HVDC buses.

In the present embodiment, the number of HVDC buses in the HVDC bus system may be configured appropriately based on the size and requirements of the electrical device.

In some exemplary embodiments, in the event that the HVDC bus system includes a plurality of HVDC buses, each HVDC bus may include, but is not limited to, being connected to a group of the medium-low voltage power distribution system, the high-voltage battery backup power system and the power distribution system, and the plurality of HVDC buses being connected in parallel.

In the present embodiment, the power supply and backup of various data centers of different magnitudes may be achieved through the rational deployment of a plurality of HVDC buses, a medium-low voltage power distribution system, a high-voltage battery backup power system and a power distribution system.

In the present embodiment, the power supply and backup networks to which the plurality of HVDC buses are respectively connected may further include, but is not limited to, mutually redundant backup.

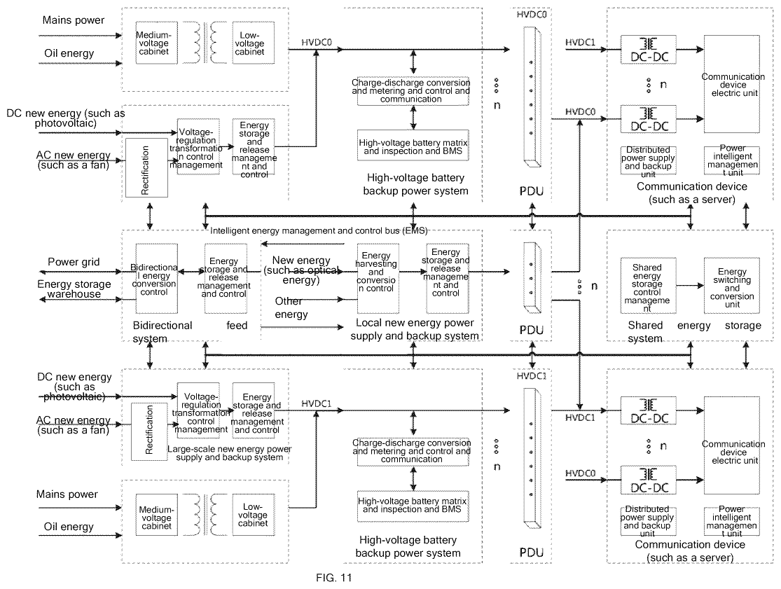

In some embodiments, a power supply and backup network for a high-level data center sharing an HVDC bus is provided. FIG. 11 is a schematic diagram showing a power supply and backup network for a high-level data center sharing an HVDC bus according to some embodiments of the present application, as shown in FIG. 11, the power supply and backup network for a high-level data center sharing an HVDC bus is formed by the interlaced expansion and merging of the above-mentioned power supply and backup network for a data center sharing an HVDC bus. Based on the fundamental design concept of the above-mentioned power supply and backup network for a high-level data center sharing an HVDC bus, its variations and extensions include, but are not limited to, the power supply and backup network for a high-level data center sharing an HVDC bus. The power supply and backup network for a high-level data center sharing an HVDC bus allows conventional design operations including but not limited to expansion, simplification, interlacing, cascading, and mutual backup for its constituent basic functional unit systems.

The power supply and backup network for a high-level data center sharing an HVDC bus is constructed through the interlaced parallel expansion of two sets of the above-mentioned power supply and backup network for a data center sharing an HVDC bus. It includes seven basic units: a medium-low voltage power distribution system, a large-scale new energy power supply and backup system, a high-voltage battery backup power system, PDUs and a communication device, a local new energy power supply and backup system with PDUs, a bidirectional feed system, and a shared energy storage system. The key distinction between the two configurations resides in: the dual-power paths being cross-connected to mutually back up each other for supplying power to the communication device, thereby enhancing power supply reliability for the communication device; while the local new energy power supply and backup system and PDU expansion establish two (or more) isolated power supply and backup channels that, together with the dual-main power paths, collectively form a cross-connected shared power supply bus system and a cross-connected shared backup bus system.

The schematic diagram showing the power supply and backup network for a high-level data center sharing an HVDC bus is a simplified schematic block diagram, which includes but is not limited to the above-mentioned seven basic units, and includes but is not limited to the current double cross-connected shared power supply and backup HVDC bus system architecture configuration. Each basic unit may be added or subtracted from the actual data center networking design, so as to form power supply and backup network for a data center sharing an HVDC bus with different levels and different site needs. HVDC is short for high-voltage direct current, which provides DC power supply with relatively stable voltage and no directional reversal. Its voltage range covers 48 Vdc and higher DC voltages, including but not limited to typical values such as 240 Vdc, 336 Vdc, 380 Vdc, and 400 Vdc.

The power supply and backup network for a high-level data center sharing an HVDC bus is constructed through the interlaced parallel expansion of the above-mentioned power supply and backup network for a data center sharing an HVDC bus. The local new energy power supply and backup system adopts an integrated design, where each functional unit system may be expanded through cascading and interlaced parallel expansion according to implementation requirements. The power supply and backup network for a high-level data center sharing an HVDC bus may form a master-slave or master-backup shared HVDC bus system for supplying power by means of dual-main paths of HVDC0 and HVDC1, and may also constitute a shared HVDC dual-bus power supply green energy-saving system powered by dual-main path power supply of HVDC0 and HVDC1. For clarity of description, the shared HVDC dual-bus green energy-saving power supply and backup system powered by the dual-main path power supply of HVDC0 and HVDC1 shall be taken as an exemplary embodiment. In addition to the above-mentioned functions of the power supply and backup network for a data center sharing an HVDC bus, the power supply and backup network for a high-level data center sharing an HVDC bus also has the following functions:

The power supply and backup network for a high-level data center sharing an HVDC bus includes but is not limited to a medium-low voltage power distribution system, a large-scale new energy power supply and backup system, a high-voltage battery backup power system, a communication device, a local new energy power supply and backup system, a bidirectional feed system, a shared energy storage system and other basic functional unit systems, and are interconnected through the shared HVDC bus, resulting in higher reliability of the power system. The shared HVDC dual-bus power supply and backup network of HVDC0 and HVDC1, which is powered by the dual-main paths, forms the fact that the dual shared HVDC bus accesses, and completes the networking configuration of the power supply and backup system in the high-level data center. Dual-power transformation and power distribution power supply and backup network access, through the staggered grid isolation control, to achieve HVDC0 and HVDC1 in either main path power loss state parallel machine sharing, to maintain dual-power redundant access architecture of the electrical device of the data center.

The medium-low voltage power distribution system directly outputs the dual-main path power system HVDC0 and HVDC1 through isolation conversion technology, flexible power transformation technology, or other conversion technologies from mains power and oil energy backup power, thereby distributing system power consumption and reducing current conduction losses in the dual-main path power supply by up to half, which achieves energy-saving and loss-reduction in the HVDC bus power supply current paths, making significant contributions to the green, low-carbon, low-PUE, and high-reliability design.

The shared HVDC dual-bus power supply and backup network incorporates two mutually redundant high-voltage battery backup power systems with ACDC and DCAC conversion stages eliminated, thereby reducing the number of main circuit converter conversion stages, decreasing main circuit power losses, achieving low PUE values, and facilitating energy conservation, emission reduction, and green low-carbon operation. In addition, the two mutually redundant high-voltage battery backup power systems may use HVDC0 and HVDC1 dual-input to achieve interlaced redundant backup power access. This configuration enables dual-input capability for both main and backup energy storage units in the energy storage system, thereby enhancing the reliability of the backup power system. Consequently, it improves the backup power reliability for the data center and ensures more secure and reliable operation of business data of the data center.

The high-voltage battery backup power system is bypassed on the shared HVDC0 and HVDC1 double-buses to provide backup power for the entire data center or other electrical facilities; in the event of abnormal power supply of any medium-low voltage power distribution system, the abnormal medium-low voltage power distribution system is disconnected to release the energy of the high-voltage battery backup power system to its corresponding shared HVDC bus, so as to ensure the normal operation of the entire data center or other electrical facilities for a certain repair time and ensure the reliable operation of the electrical device. A high-voltage battery backup power system bypassed on a power supply bus with abnormal disconnection in the medium-low voltage power distribution system maintains operational capability to charge through the non-faulty bus power line even when the faulty shared bus is disconnected, which maintains the power supply device on the abnormal bus by either extending operation time of the power supply device or sustaining normal operation without reliability incidents until the power supply of the medium-low voltage power distribution system is restored, after which the backup system configuration returns to its default state. The high-voltage battery backup power system in non-fault condition corresponding to the shared bus may synchronously switch into the power supply bus with abnormal disconnection in the medium-low voltage power distribution system, maintaining the dual-redundant power supply access architecture for an electrical device of the data center and ensuring normal power operation for power supply devices on the abnormal bus without reliability incidents, until power supply of the medium-low voltage power distribution system is restored, after which the shared HVDC bus configuration returns to the dual-input bus state.

In the extreme scenario of complete failure of the medium-low voltage power distribution system, during the energy discharge process of the dual high-voltage battery backup power systems, they first form a power loss hold backup power system with the local new energy power supply and backup system; after energy of the local new energy power supply and backup system discharges to a lower limit, they then form a power loss hold backup power system with the energy storage warehouse of the bidirectional feed system (in the event of no third mains power connection or when the third mains power also fails; if a normally operable third mains power exists, it is used as a third primary backup power redundancy to continue powering the electrical device of the data center); when energy of the energy storage warehouse of the bidirectional feed system discharges to the lower limit, the dual high-voltage battery backup power systems respectively form independent power loss hold backup power systems with their corresponding large-scale new energy power supply and backup systems on their shared buses; after each large-scale new energy power supply and backup system discharges to its respective lower limit, the dual high-voltage battery backup power systems separately discharge their remaining energy; when either energy of the high-voltage battery backup power system discharges to the lower limit, regardless of whether the new energy power supply and backup system on the other HVDC bus has discharged energy to reach the lower limit, the HVDC0 and HVDC1 buses are merged to ensure continuous power supply for the communication device and business data security/reliability during this extreme complete failure scenario of the entire medium-low voltage power distribution system of the data center. For other potential failure scenarios, the power loss energy discharge mechanism for data security protection follows similar principles and methodologies as described above, which will not be repeated herein. It may be seen that the shared interlaced HVDC dual-bus system possesses enhanced redundancy and fault tolerance capabilities, ensuring exceptionally high power supply and backup reliability for data centers or other electrical facilities and systems.

The large-scale new energy power supply and backup system and local new energy power supply and backup system, while maintaining normal data center operation, may utilize any surplus energy to replenish the high-voltage battery backup power system and distributed power supply and backup units for the communication device, store excess energy in the energy storage warehouse of the bidirectional feed system when there is additional surplus energy, and feed the still additional surplus energy back to the power grid for grid-connected power generation. To achieve local storage, warehouse storage and grid-connected power generation in the event of sufficient local new energy, whereby the collected new energy may be rationally utilized, lower PUE and low-carbon green sharing may be achieved.

The primary function of the high-voltage battery backup power system is centralized backup power supply for the electrical device, while concurrently possessing shared HVDC bus voltage fluctuation smoothing functionality to maintain the shared HVDC bus voltage within a specified range, thereby ensuring relatively stable power input for the communication device. Under the dual HVDC shared bus system configuration, the dual high-voltage battery backup power systems achieve dual-interleaved input backup, thereby realizing the HVDC bus voltage interleaved mutual regulation function.

The shared HVDC bus power distribution power supply and backup network, composed of medium-low voltage power distribution systems, new energy power supply and backup systems, and high-voltage battery backup power systems, forms a grid-patterned shared HVDC dual-bus power distribution and backup network through interleaved parallel and cross configurations, and provides a shared HVDC dual-bus power supply and backup input for a communication device (an electrical facility or an electrical unit) via an energy distribution metering of an intelligent management and control system and a management control system by means of PDU and a combination form thereof.

The multiple power distribution units formed by PDUs and their combined configurations distribute HVDC0 and HVDC1 output from the dual power transformation, power distribution and backup power system to provide cross-redundant power supply and backup for each electrical device. Different PDU configurations and combinations may form different power distribution power supply architectures, enabling redundant power supply and backup systems, dual-bus dual-backup shared systems, multi-bus heterogeneous backup systems, and the like.

There are two communication device frames in the schematic block diagram showing the power supply and backup network for a high-level data center sharing an HVDC bus, which are both communication devices or electrical units in the data center (or other electrical facilities). These are included solely to more clearly and intuitively demonstrate the redundant interleaved power supply and backup architecture of the shared HVDC dual-bus network. Certainly, this configuration also accommodates the communication device with different power supply level requirements by implementing differentiated node-level power supply and backup access and control, which may simplify and optimize the scale and configuration of the power supply and backup system, enabling cost reduction for the low-carbon, low-PUE, high-reliability power supply and backup system. The communication device is an electrical terminal device unit, and may include, but is not limited to, electronic devices such as servers, switches, storage servers, base stations, and the like. The communication device internally contains a DCDC conversion unit, referred to herein as an HVDC PSU, which may include, but is not limited to this configuration, with the functional capability of supporting DC voltage input. The communication device may also internally include distributed power supply and backup units or include self-backup power and self-redundant PSUs, or energy conversion and transformation apparatuses.

The large-scale new energy power supply and backup system cooperates with the medium-low voltage power distribution system to form a power transformation, power distribution and backup power system that provides HVDC and backup power for a data center or other electrical facilities. In the power supply and backup network for a high-level data center sharing an HVDC bus, two sets of mutually redundant power transformation, power distribution and backup systems may be streamlined into two sets of mutually redundant medium-low voltage power distribution systems sharing one large-scale new energy power supply and backup system, which allocates power to both the HVDC0 and HVDC1 dual-bus systems for new energy power supply and backup. This configuration avoids redundant construction and enables cost reduction for the high-level data center shared HVDC dual-bus system featuring low-carbon, low-PUE, and high-reliability power supply and backup. To further reduce infrastructure costs, while the two medium-low voltage power distribution systems share a single large-scale new energy system, the bidirectional feed system and the energy storage warehouse may be integrated into a unified design, which significantly reduces the infrastructure costs for the entire system, including power transformation and power distribution, new energy power supply and backup, bidirectional feed, and energy storage. Of course, this is suitable for the event that the two sets of medium-low voltage systems and large-scale new energy systems are not far away from each other. When the physical distance between the two sets of medium-low voltage systems and large-scale new energy systems is very long, it is also impossible that the two sets of systems are respectively equipped with a bidirectional feed system and an energy storage warehouse, whereby the redundancy is more sufficient and reliable, but the cost is relatively high.

The large-scale new energy power supply and backup system is used as either a data center auxiliary power system which is mutually redundant with the respective main medium-low voltage power distribution systems, a backup power system of the data center which is mutually redundant with the respective main high-voltage battery backup power systems, and a constant-current and trickle energy storage system for energy storage and replenishment of the respective main high-voltage battery backup power system, thereby forming a highly redundant dual-main circuit backup system with both primary/auxiliary power paths and dual backup paths. When the mutually redundant large-scale new energy power supply and backup systems have collected surplus new energy, they may feed the excess power to either the bidirectional feed system and its energy storage warehouse, or the grid's energy storage infrastructure.

The large-scale new energy power supply and backup system is used as a power system, and a multi-loop control auxiliary intelligent management and control bus with constant-voltage and constant-current or constant power is used for real-time control, so as to ensure that the large-scale new energy power supply and backup system, when the energy is sufficient therein, is used as a primary power supply source for a data center, and a medium-low voltage power distribution system is used as a secondary power supply source for the data center. When the energy of large-scale new energy power supply and backup system is sufficient, it may provide HVDC power for the data center or other electrical facilities. When the large-scale new energy power supply and backup system still has surplus energy that may not be stored internally under such circumstances, the power may be fed to the bidirectional feed system and its energy storage warehouse, the grid's energy storage facilities, or fed back to the power grid; when the energy of the large-scale new energy power supply and backup system reaches the backup power energy threshold, the system is automatically converted to the backup power system and starts collecting and storing energy, while the medium-low voltage power distribution system acts as the main power and ceases energy storage to the bidirectional feed system and its energy storage warehouse.

When the large-scale new energy power supply and backup systems all become backup power systems, that is to say, there is no surplus new energy for the two large- scale new energy power supply and backup systems to be transferred to the bidirectional feed system, and the system is configured as a warehouse feed system. At this time, the bidirectional feed system and energy storage warehouse also become the backup power system, which may be considered as a further effective expansion of the high-voltage battery backup power system, forming a centralized and decentralized backup power system. Under the same scale and requirements of the data center, the capacity of high-voltage battery backup power system may be further reduced to ensure high reliability of the data center, while reducing the backup power space and cost in the data center, and reducing the difficulty of maintenance.

The large-scale new energy power supply and backup system is used as a constant-current and trickle energy storage system to implement energy storage and replenishment for the high-voltage battery backup power system, and constant-current mode control and trickle mode control are adopted to achieve energy localized reserve and replenishment in the event of sufficient new energy for the large-scale new energy power supply and backup system; if there remains collected available new energy requiring storage due to capacity limitations of the high-voltage battery backup power system, the localized bidirectional feed system and its energy storage warehouse may be configured to either store surplus new energy or feed it back to the power grid, or be integrally designed as a unified system with the local new energy power supply and backup system to achieve local new energy power supply, backup power, and feed, so as to rationally utilize new energy to achieve lower PUE and achieve low-carbon green HVDC bus power supply and backup architecture.

In addition to the basic functions of the local new energy power supply and backup system in the above-mentioned power supply and backup network for a data center sharing an HVDC bus, the local new energy power supply and backup system may achieve the isolation output of the HVDC0 and the HVDC1, achieve the HVDC shared double-bus local new energy power supply and backup, provide the electrical device of the data center device power supply and backup isolation, and thus cooperate with the interleaved redundancy to improve the reliability of the power supply and backup network for the high-level data center sharing an HVDC bus.

In addition to the basic functions of the intelligent management and control bus system in the power supply and backup network for a data center sharing an HVDC bus, the intelligent management and control bus system also has higher control complexity. In the event that the inner loop of the overall power supply and backup network itself is controlled to work stably, the outer loop intelligent management and control may be formed according to the state information of the overall power supply and backup network, thereby optimizing energy flow management to achieve superior low-carbon, low-PUE green energy efficiency objectives.

The bidirectional feed system is configured to control the storage and release of surplus energy to an energy storage warehouse and/or a power grid and to release the energy storage warehouse and/or the power grid to an HVDC bus for the operation of an electrical device. To achieve “valley storage for peak usage” of surplus energy, enabling full and rational utilization of new green energy while minimizing waste of collected energy. The bidirectional feed system may be integrated with the large-scale new energy power supply and backup system and/or the local new energy power supply and backup system, and may also be a bridge between the two.

The bidirectional feed system stores valley period surplus energy by respectively allocating new energy surplus from both HVDC0 and HVDC1 buses to two isolated but interconnectable energy storage warehouses. During peak periods, the bidirectional feed system's energy release operation, based on intelligent management and control bus analysis and prediction, maintains default discharge modes of corresponding bus release, interleaved bus release, or merged release.

When the dual large-scale new energy power supply and backup systems and/or the dual local new energy power supply and backup systems generate energy surplus during valley operation periods of the electrical device of the data center, through the predictive analysis by the intelligent management and control bus, it is determined whether to store the surplus in the energy storage warehouse and/or power grid, in some embodiments, to local energy storage systems such as the energy storage warehouse. When the energy storage warehouse reaches full capacity, excess energy may then be fed back to the power grid. To ensure valley-period storage and conversion of green new energy collected by the large-scale new energy power supply and backup system and/or local new energy power supply and backup system, thereby creating peak-period energy storage without wasting surplus energy.

The bidirectional feed system releases stored energy during peak periods. The surplus energy in the energy storage warehouse is discharged during predicted peak operational periods of the electrical device of the data center by the intelligent management and control bus system. This method both conserves mains power supply energy and reduces energy waste, further achieving low-carbon operations with reduced PUE, while ensuring stable and highly reliable operation of the large-scale new energy power supply and backup system and/or local new energy power supply and backup system.

The shared energy storage system, while retaining all basic functions of the shared energy storage system in the above-mentioned power supply and backup network for a data center sharing an HVDC bus, may be configured with multiple redundant shared energy storage systems and distributed power supply and backup units according to the number of independently shared buses in the input power supply device. The power supply and backup network for a high-level data center sharing an HVDC bus includes at least dual HVDC buses including HVDC0 and HVDC1, which may be expanded with two sets of shared energy storage systems and distributed power supply and backup units to achieve either independently redundant or interlaced redundant distributed backup power configurations.

Through the description of the foregoing embodiments, a person skilled in the art may clearly understand that the methods according to the above-mentioned embodiments may be implemented by means of software plus a necessary general-purpose hardware platform, and certainly may also be implemented through hardware, but in many cases the former is a better implementation. Based on such understanding, the technical solution of the present application, or the part contributing to the related art, may be embodied in the form of a software product, which is stored in a non-volatile readable storage medium (such as ROM/RAM, magnetic disk, or optical disc) and includes several instructions to enable a terminal device (which may be a mobile phone, computer, server, or network device, and the like.) to execute the methods of the various embodiments of the present application.

The examples in the present embodiment may refer to the examples described in the foregoing embodiments and implementations, and details are not repeated herein.

Apparently, a person skilled in the art should understand that the modules or steps of the present application described above may be implemented by a general-purpose computing device, which may be centralized on a single computing device or distributed across a network composed of a plurality of computing devices. In some embodiments, they may be implemented using program code executable by the computing device, and thus may be stored in a storage device for execution by the computing device. In some cases, the steps illustrated or described may be performed in an order different from that described herein, or they may be fabricated into individual integrated circuit modules, or a plurality of modules or steps may be fabricated into a single integrated circuit module for implementation. Thus, the present application is not limited to any specific combination of hardware and software.

The foregoing is merely embodiments of the present application. It should be noted that, for a person skilled in the art, various modifications and refinements may be made without departing from the principles of the present application, and such modifications and refinements shall also be regarded as falling within the protection scope of the present application.

1. A power supply and backup network of a communication device, comprising: a medium-low voltage power distribution system, a high-voltage battery backup power system, a power distribution system and a high-voltage direct-current (HVDC) bus system, wherein
the medium-low voltage power distribution system is connected to the power distribution system by means of the HVDC bus system, and the high-voltage battery backup power system is bypassed on the HVDC bus system;
the medium-low voltage power distribution system is configured to use input mains power and oil energy backup power to provide HVDC power for the power distribution system by means of the HVDC bus system;
the high-voltage battery backup power system is configured to provide HVDC backup power for the power distribution system by means of the HVDC bus system; and
the power distribution system is configured to distribute, to an electrical device connected to the power distribution system, the HVDC power transmitted on the HVDC bus system.

2. The power supply and backup network according to claim 1, wherein
the medium-low voltage power distribution system is configured to charge the high-voltage battery backup power system in response to normal power supply; and
the high-voltage battery backup power system is configured to discharge the HVDC bus system in response to abnormal power supply in the medium-low voltage power distribution system.

3. The power supply and backup network according to claim 2, wherein the high-voltage battery backup power system is further configured to smooth voltage fluctuations on the HVDC bus system.

4. The power supply and backup network according to claim 1, further comprising:
a new energy power supply and backup system, wherein
the new energy power supply and backup system is connected to the HVDC bus system; and
the new energy power supply and backup system is configured to use input new energy to provide the HVDC power for the power distribution system or the HVDC backup power for the power distribution system by means of the HVDC bus system.

5. The power supply and backup network according to claim 4, wherein the new energy power supply and backup system comprises: a first new energy power supply and backup system and a second new energy power supply and backup system, wherein
the first new energy power supply and backup system is disposed at a remote end of the electrical device and the second new energy power supply and backup system is disposed locally at the electrical device.

6. The power supply and backup network according to claim 5, wherein
the first new energy power supply and backup system and the medium-low voltage power distribution system are configured as mutually redundant power supply systems; and
the first new energy power supply and backup system and the high-voltage battery backup power system are configured as mutually redundant backup power systems.

7. The power supply and backup network according to claim 6, wherein
in response to a determination that energy in the first new energy power supply and backup system is higher than a first threshold, the first new energy power supply and backup system is configured as a primary power supply source for the electrical device, and the medium-low voltage power distribution system is configured as a secondary power supply source for the electrical device.

8. The power supply and backup network according to claim 6, wherein the first new energy power supply and backup system is further configured to perform trickle charging energy storage for the high-voltage battery backup power system.

9. The power supply and backup network according to claim 5, wherein
the second new energy power supply and backup system and the medium-low voltage power distribution system are configured as mutually redundant power supply systems;
the second new energy power supply and backup system and the high-voltage battery backup power system are configured as mutually redundant backup power systems; and
the second new energy power supply and backup system and a first distributed power supply and backup unit disposed in the electrical device are further configured as second mutually redundant backup power systems.

10. The power supply and backup network according to claim 9, wherein
in response to a determination that energy in the second new energy power supply and backup system is higher than a second threshold, the second new energy power supply and backup system is configured as a primary power supply source for the electrical device, and the medium-low voltage power distribution system and the first new energy power supply and backup system are configured as a secondary power supply source for the electrical device.

11. The power supply and backup network according to claim 9, wherein
the second new energy power supply and backup system is further configured to perform constant-current energy storage or trickle charging energy storage for the high-voltage battery backup power system; or,
the second new energy power supply and backup system is further configured to perform the constant-current energy storage or the trickle charging energy storage for the first distributed power supply and backup unit disposed in the electrical device.

12. The power supply and backup network according to claim 4, further comprising: a bidirectional feed system, wherein
the bidirectional feed system is configured to store valley period surplus energy from the new energy power supply and backup system into an energy storage warehouse, and supply power to a power grid after the energy storage warehouse is fully charged; and
the bidirectional feed system is further configured to provide energy stored in the energy storage warehouse or energy provided by the power grid to the electrical device during peak power consumption period of the electrical device.

13. The power supply and backup network according to claim 1, further comprising: a shared energy storage system, wherein
the shared energy storage system is connected to the HVDC bus system; and
the shared energy storage system is configured to store energy to a first distributed power supply and backup unit disposed on the electrical device or release energy to the first distributed power supply and backup unit disposed on the electrical device by means of the HVDC bus system.

14. The power supply and backup network according to claim 13, wherein
the shared energy storage system is configured to allocate a second distributed power supply and backup unit for providing backup power in response to a failure of a system for supplying power in the power supply and backup network; and
the shared energy storage system is further configured to switch a backup power system to the first distributed power supply and backup unit disposed on the electrical device before energy stored in the backup power system in the power supply and backup network is discharged to a limiting threshold in response to the failure of the system for supplying power in the power supply and backup network.

15. The power supply and backup network according to claim 1, wherein the electrical device comprises: a communication device, and an HVDC Power Supply Unit (HVDC PSU) is disposed in the communication device, and
the HVDC PSU comprises a power supply conversion apparatus that conforms to direct-current (DC) input.

16. The power supply and backup network according to claim 15, wherein the power supply conversion apparatus comprises: a direct-current to direct-current (DCDC) isolation converter, a self-backup power DCDC isolation converter, or a self-redundant DCDC isolation converter.

17. The power supply and backup network according to claim 15, wherein the communication device is further deployed in a third distributed power supply and backup unit, wherein
the third distributed power supply and backup unit is configured to provide backup power to the communication device.

18. The power supply and backup network according to claim 1, further comprising: an intelligent management and control bus system, wherein
the intelligent management and control bus system is connected to all functional systems comprised in the power supply and backup network; and
the intelligent management and control bus system is configured to monitor all the functional systems, and regulate and control a power supply system and a backup power system of the power supply and backup network according to a working state of all the functional systems.

19. The power supply and backup network according to claim 1, wherein the HVDC bus system comprises: one or more HVDC buses.

20. The power supply and backup network according to claim 19, wherein
in response to a determination that the HVDC bus system comprises a plurality of HVDC buses, each of the plurality of HVDC buses is connected to a group of the medium-low voltage power distribution system, the high-voltage battery backup power system and the power distribution system, and the plurality of HVDC buses are connected in parallel.
